(19) United States
(12) Patent Application Publication
(10) Pub. No.: US 2015/0259081 A1
(43) Pub. Date: Sep. 17, 2015

(54) INTEGRATED ARMOR FOR HYPERVELOCITY IMPACTS

(71) Applicant: The Boeing Company, Chicago, IL (US)

(72) Inventors: Jeremie J. Albert, Philadelphia, PA (US); Richard R Laverty, Philadelphia, PA (US); Jonathan W. Gabrys, Dowingtown, PA (US); Russell F. Graves, Friendswood, TX (US)

(73) Assignee: The Boeing Company, Chicago, IL (US)

(21) Appl. No.: 14/209,052

(22) Filed: Mar. 13, 2014

(51) Int. Cl. B64G 1/56; F41H 5/06; F41H 5/02

(52) U.S. Cl. CPC B64G 1/56; F41H 5/02; F41H 5/06

(57) ABSTRACT

Apparatus and methods described herein provide for a structural armor configured to provide load-bearing capabilities to a structure, as well as to provide protection from hypervelocity impacts. According to one aspect of the disclosure provided herein, the structural armor may include two armor facesheets, with an angular member core disposed between. The angular member core may include a number of nodes abutting the armor facesheets, with angular members intersecting at the nodes at acute node angles from the armor facesheets and extending between the armor facesheets. The acute node angles correspond with estimated spread angles of a debris field resulting from an impact of an object with an armor facesheet while moving at hypervelocity speed.

### BACKGROUND

Spacecraft, satellites, and other structures (hereinafter “space structures”) orbiting in space outside of the Earth's atmosphere are subjected to various environmental hazards. One such hazard includes the potential for impact with objects or debris traveling at hypervelocity speeds. Even very small particles colliding with a space structure have the potential to cause significant damage due to the speed at which the particles are moving.

To minimize damage to a space structure from impacts with debris in space, the structure may be protected with a Whipple shield, which consists of two plates that are spaced apart. When the debris impacts and penetrates the outermost plate, the debris cloud from the impact spreads out between the plates before being absorbed by the second plate. However, as the Whipple shield provides no structural purpose for the associated space structure, it is positioned externally to the walls or surfaces of the structure to be protected. In doing so, the Whipple shield increases the thickness of the walls and adds weight, neither of which is desirable since minimizing the size and weight of space structures are primary considerations when launching the structures into orbit.

It is with respect to these considerations and others that the disclosure made herein is presented.

### SUMMARY

It should be appreciated that this Summary is provided to introduce a selection of concepts in a simplified form that are further described below in the Detailed Description. This Summary is not intended to be used to limit the scope of the claimed subject matter.

Systems, methods, and apparatus described herein provide for a structural armor that provides load-bearing support to a space structure, as well as providing protection against hypervelocity impacts. According to one aspect of the disclosure provided herein, a structural armor includes a front armor facesheet and a rear armor facesheet offset from the first. An angular member core occupies the space between the front armor facesheet and the rear armor facesheet. The angular member core includes a number of nodes abutting the front armor facesheet and the rear armor facesheet. A number of angular members intersect at an acute node angle from the front armor facesheet or the rear armor facesheet. The acute node angle is selected according to a spread angle of a debris field resulting from a hypervelocity impact of an object with the front armor facesheet. The angular member core is configured to provide load-bearing capability for a structure.

According to another aspect, a method of protecting a space structure from an impact with an object moving at hypervelocity speed includes receiving a penetrating impact from the object on a front armor facesheet of a structural armor. Debris from the penetrating impact is conically distributed outward at a spread angle through an angular member core to a rear armor facesheet of the structural armor.

According to yet another aspect, a method of providing a structural armor for protecting a space structure from an impact with an object moving at hypervelocity speed is provided. The method includes configuring an angular member core with a number of nodes and a number of angular members intersecting at the nodes according to acute node angles from a front armor facesheet or a rear armor facesheet. The acute node angles correspond to a spread angle of a debris field resulting from a hypervelocity impact of an object with the front armor facesheet. The front armor facesheet and the rear armor facesheet are coupled to the angular member core such that the angular members extend from the front armor facesheet to the rear armor facesheet.

The features, functions, and advantages that have been discussed can be achieved independently in various embodiments of the present disclosure or may be combined in yet other embodiments, further details of which can be seen with reference to the following description and drawings.

### BRIEF DESCRIPTION OF THE DRAWINGS

FIGS. 1A and 1B are cross-sectional views of a conventional Whipple shield illustrating characteristics of a debris field within the Whipple shield from the impact of an object with a front facesheet of the Whipple shield;

FIG. 2 is a cross-section view of a conventional honeycomb structure and a Whipple shield to compare characteristics of a debris field resulting from an impact with an object;

FIG. 3 is a cross-section view of a structural armor and a Whipple shield to compare characteristics of a debris field resulting from an impact with an object, according to one embodiment presented herein;

FIG. 4 is a perspective view of a portion of an angular member core of a structural armor according to one embodiment presented herein;

FIGS. 5A-5D are perspective views of an object impacting various areas within an angular member according to various embodiments presented herein;

FIG. 6 is an energy graph comparing the kinetic energy over time of an object and corresponding debris field passing through a Whipple shield, a honeycomb structure, and various areas within an angular member core of a structural armor according to various embodiments presented herein;

FIG. 7 is a flow diagram illustrating a method of providing a structural armor for protecting a structure from an impact with an object moving at hypervelocity speed according to various embodiments presented herein; and

FIG. 8 is a flow diagram illustrating a method of protecting a structure from an impact with an object moving at hypervelocity speed according to various embodiments presented herein.

### DETAILED DESCRIPTION

The following detailed description is directed to apparatus and methods corresponding to a structural armor that provides structural support to a spacecraft or other structure, as well as providing protection against hypervelocity impacts. References are made to the accompanying drawings that form a part hereof, and which are shown by way of illustration, specific embodiments, or examples. Like numerals represent like elements through the several figures.

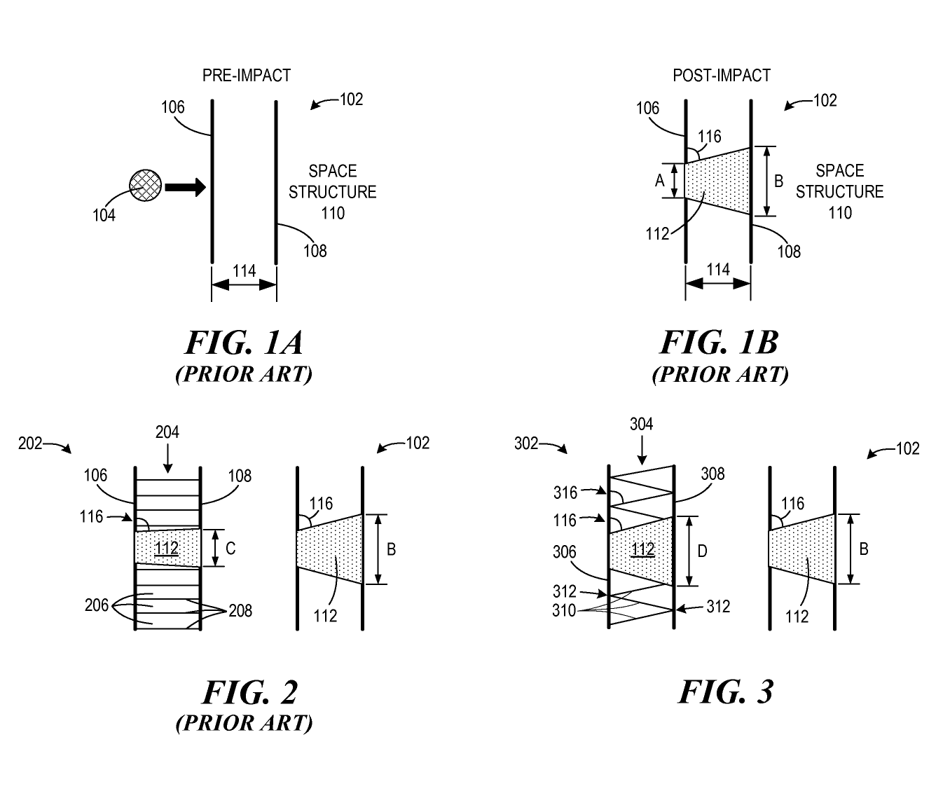

As discussed briefly above, space structures are vulnerable to damage caused by objects travelling through space at hypervelocity speeds. Whipple shields may provide some degree of protection to these types of impacts, but undesirably add to the thickness of the walls of the space structure being protected, while offering no structural or load-bearing benefits. FIGS. 1A and 1B are cross-sectional views of a Whipple shield 102 mounted to a space structure 110. These figures will be used to illustrate an example of an object 104 impacting the Whipple shield 102 and to visualize characteristics of the resulting debris field 112 within the Whipple shield 102, which will assist in understanding various concepts disclosed below. The Whipple shield 102 includes a front facesheet 106 and a rear facesheet 108 spaced apart from one another by a distance 114. FIG. 1A shows the Whipple shield 102 pre-impact, or before the object 104 contacts the front facesheet 106, while FIG. 1B shows the Whipple shield post-impact, or after the object 104 has penetrated the front facesheet 106.

When the object 104 penetrates the front facesheet 106, a debris field 112 spreads outward from the front facesheet 106 towards the rear facesheet 108 in substantially a conical shape, as shown in FIG. 1B. The conical shape provides a spread angle 116, as measured from the surface of the front facesheet 106. Through testing and analysis for an illustrative example utilizing an aluminum object 104, front facesheet 106 and rear facesheet 108, it has been determined that the spread angle 116 may be approximately 60 degrees for unconstrained debris. The debris field 112, which is moving slower than the object 104 due to the impact with the front facesheet 106, then contacts the rear facesheet 108 over a rear contact area B that is larger than a front contact area A corresponding to the dimensions of the object 104 that penetrated the front facesheet 106. The slower moving debris field 112 and larger contact area with the rear facesheet 108 (rear contact area B) allows the rear facesheet 108 to further dissipate or completely absorb the remaining energy of the debris field 112. In doing so, damage to any components of a space structure 110 beyond the rear facesheet 108 is prevented or mitigated. However, as discussed above, the distance 114 between the front facesheet 106 and the rear facesheet 108 is often not desirable in space structure implementations. Moreover, the Whipple shield 102 offers limited advantages to the structure 110 other than protection, while increasing the weight of the overall space structure.

One method of attempting to provide protection to a space structure without adding an additional plate or plates externally to the walls of the structure includes utilizing a honeycomb sandwich structure to provide structural support, as well as to absorb impacts from an object 104 moving at hypervelocity speeds. FIG. 2 shows a cross-sectional view of a honeycomb structure 202, as well as a Whipple shield 102 for comparison purposes. The honeycomb structure 202 includes a front facesheet 106 and a rear facesheet 108, similar to the Whipple shield 102 described above, but a honeycomb core 204 is disposed between the facesheets. The honeycomb core 204 includes a number of cells 206 having cell walls 208 extending parallel to one another between the front facesheet 106 and the rear facesheet 108.

However, after impact with the object 104, the cells 206 bounded by the cell walls 208 create a channeling effect with the debris field 112. The channeling effect essentially constrains the debris field 112 in a manner that prevents the cone of debris from spreading outward to the degree that is prevalent with the Whipple shield 102. As can be seen in the comparison between the honeycomb structure 202 and the Whipple shield 102, the spread angle 116 of the debris field 112 is greater with the honeycomb structure 202 than the corresponding spread angle 116 of the debris field 112 of the Whipple shield 102. As a result, the rear contact area C associated with the honeycomb structure 202 is smaller than the rear contact area B of the Whipple shield 102. The smaller contact area does not allow for the degree of energy dissipation of the debris field 112 as is achieved with the Whipple shield 102. It should also be noted that filling the space between the front facesheet 106 and the rear facesheet 108 with a material such as aluminum foam rather than the honeycomb structure 202 may also be done to provide some degree of protection from hypervelocity impacts. However, the random internal structure of aluminum foam would not be effective in providing an optimal spread angle 116 of the debris field 112 and would increase the weight of the corresponding structure as compared to the concepts described below.

Looking now at FIG. 3, a cross-sectional view of a structural armor 302 according to this disclosure will be compared to the Whipple shield 102 to demonstrate the concepts and technologies described herein. According to one embodiment, the structural armor 302 includes a front armor facesheet 306 and a rear armor facesheet 308 offset from the front armor facesheet 306, with an angular member core 304 disposed between. The angular member core 304 includes a number of angular members 310 connected together at nodes 312 or junctions and extending between the front armor facesheet 306 and the rear armor facesheet 308. Each node 312 abuts either the front armor facesheet 306 or the rear armor facesheet 308. According to an alternative embodiment, a third facesheet (not shown) may be offset from the rear armor facesheet 308 with a second angular member core 304 disposed between. Doing so could provide addition protection and load-bearing capability for the space structure 110, but may undesirably increase the weight or dimensions of the space structure 110.

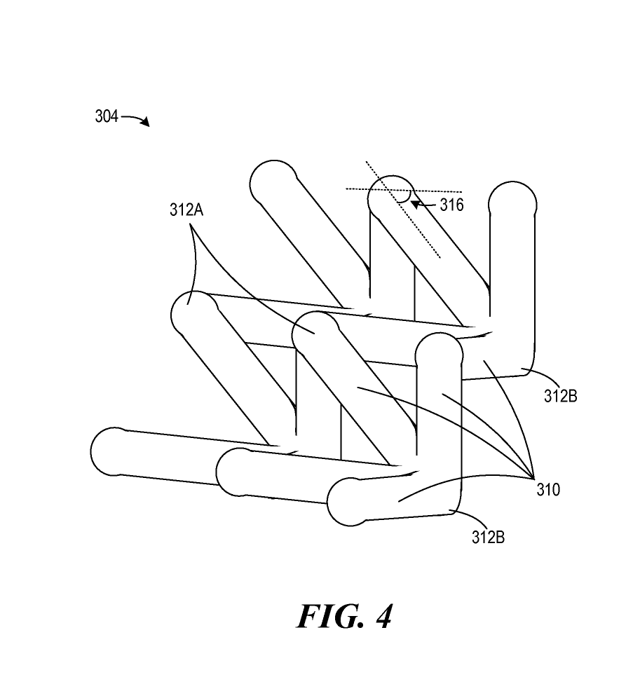

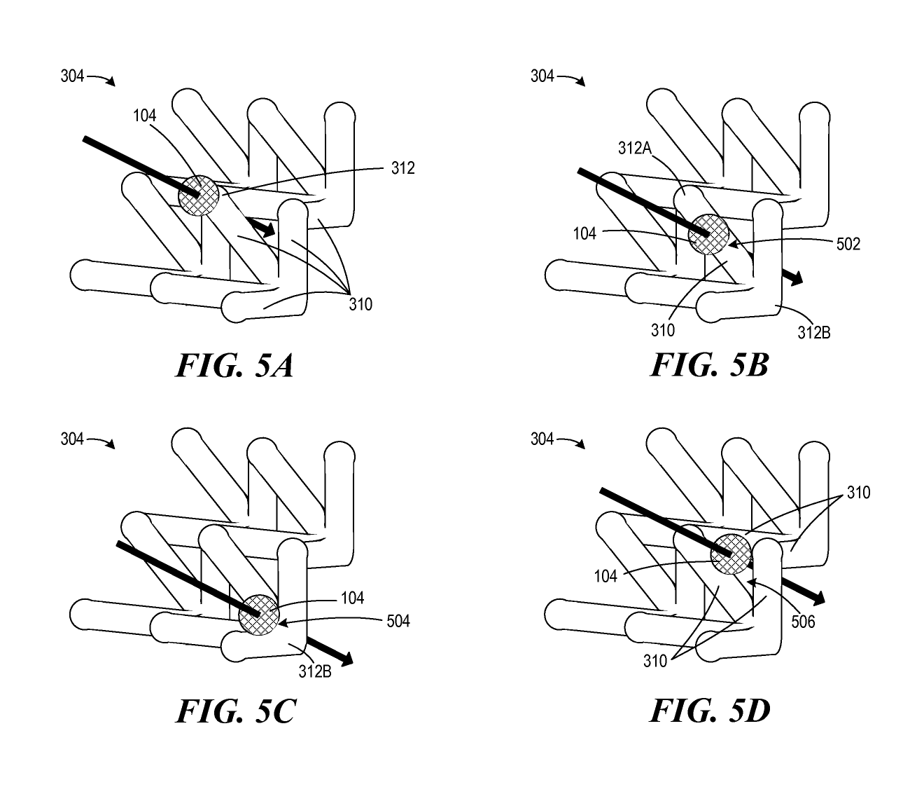

According to one embodiment described in detail below with respect to FIGS. 4-5D, each node 312 provides a junction of four angular members 310, although any number of angular members 310 may be utilized without departing from the scope of this disclosure. It can be seen in FIG. 3 that the angular members intersect at the nodes 312 abutting a facesheet such that an acute node angle 316 is created between each angular member 310 and the facesheet. According to one embodiment, the acute node angle 316 may be approximately 60 degrees, or within a range of approximately 55 to 65 degrees, although other angles are contemplated.

According to various embodiments, the acute node angle 316 may be approximately equivalent to or greater than the spread angle 116 of the debris field 112 resulting from the impact and penetration of the object 104 with the front armor facesheet 306. In doing so, the angular member core 304 eliminates or mitigates the channeling effect described above with respect to the honeycomb structure 202, allowing the debris field 112 to conically expand to the rear contact area D, which is similarly sized to the rear contact area B of the Whipple shield 102. It should become clear from this discussion that the structural armor 302 described herein is capable of dissipating the energy from an impact with an object 104 to a greater capacity than is capable with the Whipple shield 102, while additionally providing load-bearing capabilities that enable the structural armor 302 to be used as a load-bearing component of a space structure 110 as opposed to being mounted to an external surface of a load-bearing component of the space structure to serve as protection only.

Turning now to FIG. 4, a perspective view of a portion of the angular member core 304 is shown. To create the structural armor 302 described above, the angular member core 304 is bonded or otherwise coupled to a front armor facesheet 306 and a rear armor facesheet 308. According to the embodiment shown in FIG. 4, the angular member core 304 includes a number of nodes 312 and angular members 310. The nodes 312 of this example are the junctions of four angular members 310. The nodes 312 include front nodes 312A, which abut the front armor facesheet 306, and rear nodes 312B, which abut the rear armor facesheet 308, when the facesheets are coupled to the angular member core 304. As seen, each angular member 310 extends from a front node 312A to a rear node 312B according to an acute node angle 316.

It should be understood that the configuration of the angular member core 304 is not limited to the specific example shown and described with respect to FIG. 4. For example, while the angular member core 304 is shown to have four angular members 310 extending from the nodes 312, any number of angular members 310 may intersect at each node 312. According to one alternative embodiment (not shown), each node 312 may represent the junction of three angular members 310. Similarly, the angular members 310 of one embodiment may include hollow material having a circular cross-section. However, depending on the particular implementation, the angular members 310 may have a solid core or be constructed of multiple types of materials (e.g., solid core of one material with outer shell of a second material) and/or be constructed with a non-circular cross-section.

This configuration of the angular member core 304 in which the angular members 310 intersect at nodes 312 and extend from the front armor facesheet 306 and from the rear armor facesheet 308 at acute node angles 316 substantially differs from the configuration of the honeycomb core 204 described above in which the cell walls 208 extend parallel to one another between the front and rear facesheets. The benefits of the structural armor 302 with the angular member core 304 over the honeycomb structure 202 with the honeycomb core 204 lie first in the acute node angle 316. As previously discussed, the acute node angle 316 allows the debris field 112 to conically expand to the rear contact area D, which is similarly sized to the rear contact area B of the Whipple shield 102. In sum, the angular member core 304 eliminates or mitigates the channeling effect described above with respect to the honeycomb structure 202.

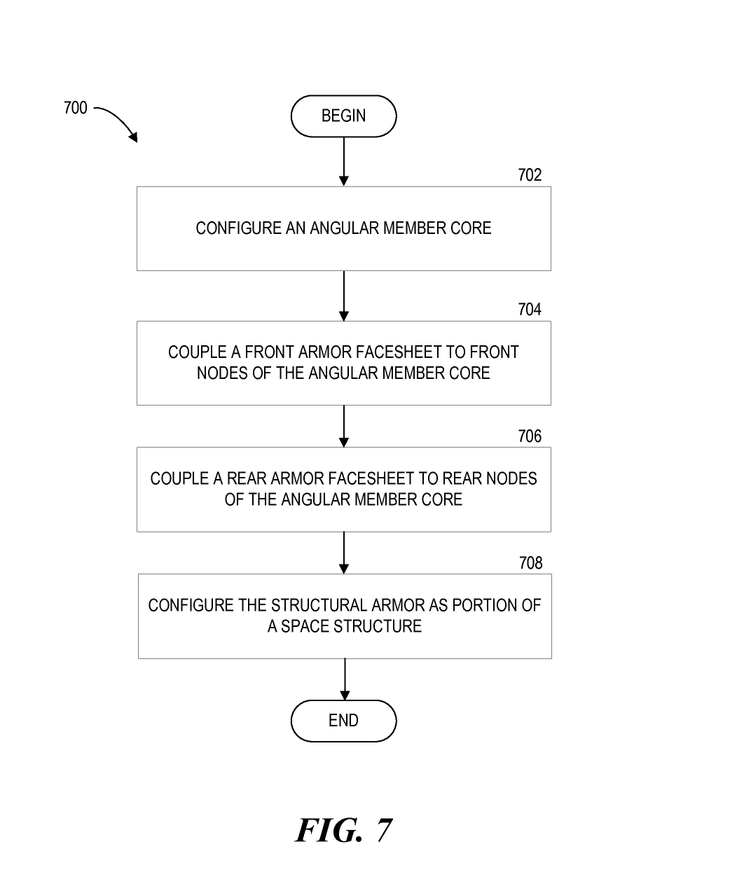

In configuring the structural armor 302, the mission parameters of the particular application will drive the specific configuration of the front armor facesheet 306, the rear armor facesheet 308, and the angular member core 304. As will be described in greater detail below with respect to FIG. 7, the characteristics of the front armor facesheet 306, the rear armor facesheet 308, and gap width between the facesheets may be selected according to the characteristics of the space structure 110 of which the structural armor 302 will be incorporated as a load-bearing component. Analysis and simulation of an impact of an object 104 with the front armor facesheet 306 will result in a spread angle 116 of the debris field 112. The acute node angle 316 may be selected according to the spread angle 116 estimated from the analysis of the hypervelocity impact of the object 104 with the front armor facesheet 306. Other characteristics of the angular member core 304, such as the number, material, cross-sectional shape and composition of the angular members 310, may be determined according to the load-bearing criteria of the particular implementation within the space structure 110.

In addition to allowing for an optimum spread angle 116 of the debris field 112, the configuration of the structural armor 302 with the angular member core 304 provides additional benefits over the honeycomb structure 202 and over the Whipple shield 102 via the positioning of the angular members 310 within the core. Specifically, by originating multiple angular members 310 at each of the nodes 312 and extending each angular member 310 at the acute node angle 316 to another node 312 on the opposite facesheet, the angular members 310 effectively “criss-cross” throughout the space between the front armor facesheet 306 and the rear armor facesheet 308. By occupying this space, in contrast to the substantial open space of the cells 206 of the honeycomb core 204 or the completely open space within the Whipple shield 102, there is an increased likelihood that the debris field 112 will contact portions of the angular members 310, which further dissipates energy from the debris field 112 as it spreads conically outward towards the rear armor facesheet 308.

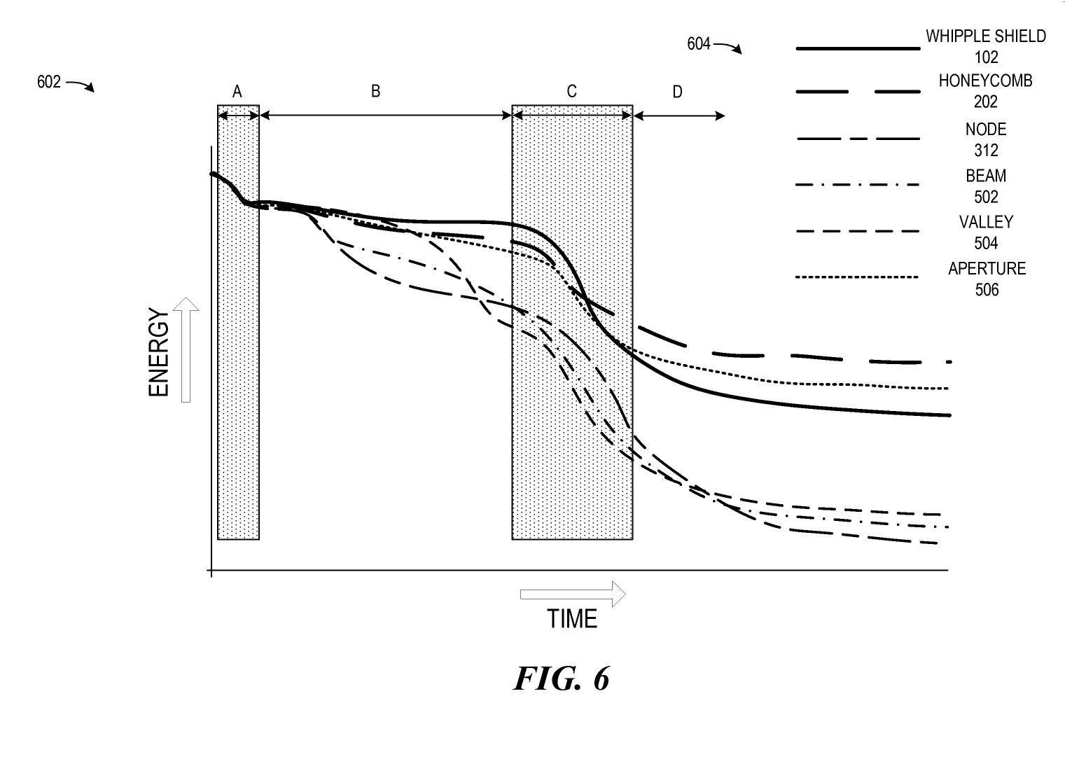

FIGS. 5A-5D illustrate this advantage of the angular members 310 occupying the space between the facesheets to increase the opportunity for the object 104 or corresponding debris field 112 to impact an angular member 310. In particular, FIGS. 5A-5D show four examples of areas within the angular member core 304 in which the object 104 may strike. FIG. 6 will visually compare the results of each of these impact areas in comparison with a honeycomb structure 202 and a Whipple shield 102. It should be appreciated that the front armor facesheet 306 and the rear armor facesheet 308 have been removed from FIGS. 5A-5D for illustrative purposes. It should be further understood that these examples are shown utilizing a depiction of an object 104 striking the angular member core 304, while during an actual impact with the front armor facesheet 306 and the rear armor facesheet 308 coupled to the angular member core 304, the object 104 may be broken into a debris field 112 prior to contact with an angular member 310.

FIG. 5A shows an example of the object 104 impacting a node 312. FIG. 5B shows an example of the object 104 impacting a beam 502 of an angular member 310. The beam 502 may be a location on the angular member 310 between the front node 312A and the rear node 312B. FIG. 5C shows an example of the object 104 impacting a valley 504 of the angular member core 304. A valley 504 is the side of a rear node 312B opposite the rear armor facesheet 308. FIG. 5D shows an example of the object 104 impacting an aperture 506 of the angular member core 304. The aperture 506 is defined by the four surrounding angular members 310.

FIG. 6 shows an energy graph 602 that plots the kinetic energy of the object 104 and corresponding debris field 112 over time for a Whipple shield 102, a honeycomb structure 202, and for impacts at the various locations of FIGS. 5A-5D with respect to a structural armor 302 having an angular member core 304 between a front armor facesheet 306 and a rear armor facesheet 308. The energy graph 602 is a result of finite element analysis (FEA) techniques. Although the results may be extrapolated to other materials and parameters without departing from the scope of this disclosure, for this analysis, the object 104 includes an approximately 0.20 inch diameter aluminum sphere impacting structural armor 302 having a front armor facesheet 306 and a rear armor facesheet 308 that are each aluminum of approximately 0.160 inch thickness. The angular member core 304 of the structural armor 302 includes four angular members 310 per node 312, each angular member 310 being hollow Inconel with an approximately 0.125 inch diameter circular cross-section. The object 104 impacts the structural armor 302 at a velocity of approximately 6.66 km/sec.

As can be seen in the energy graph 602 and corresponding legend 604, lines of various patterns represent plots of the kinetic energy over a time period for impacts at a node 312, beam 502, valley 504, and aperture 506 corresponding to FIGS. 5A-5D, respectively. These energy plots will be compared to similar plots associated with a Whipple shield 102 and honeycomb structure 202.

Looking at the energy plots in detail, period A represents the approximate time during which the object 104 travels through the front armor facesheet 306, or in the case of the honeycomb structure 202 and Whipple shield 102, the front facesheet 106. Period B of the energy graph 602 represents the approximate time through which the debris field 112 travels between the front and rear facesheets. Period C represents the approximate time during which the debris field 112 impacts and penetrates the rear armor facesheet 308, or in the case of the honeycomb structure 202 and Whipple shield 102, the rear facesheet 108. Period D represents the time after the debris field 112 penetrates the rear armor facesheet 308 or the rear facesheet 108.

In period A, all energy plots show a decrease in kinetic energy since the energy is absorbed by the applicable facesheet. As seen in period D, the kinetic energy continues to gradually decline for all energy plots after the debris field 112 penetrated the rear armor facesheet 308 or rear facesheet 108; however, it should be appreciated that the characteristics of the actual energy plot would depend upon the space structure 110 into which any remaining debris field 112 enters after leaving the facesheet. For illustrative purposes, the periods B and C will now be described with respect to the Whipple shield 102 and the honeycomb structure 202. These periods of the energy graph 602 will then be discussed with respect to the various impact areas of the structural armor 302 for comparison purposes to highlight advantages of the structural armor 302 over the Whipple shield 102 and the honeycomb structure 202.

As stated above, period B of the energy graph 602 shows the various energy plots corresponding to the debris field 112 passing between the front and rear facesheets. With respect to the Whipple shield 102, the kinetic energy of the debris field 112 decreases very little in period B after penetrating the front facesheet 106. The reason for this minor decrease is that the debris field 112 is conically expanding between the facesheets, but because there is no structure between the facesheets, there is no substantial energy loss before contact with the rear facesheet 108. With respect to the honeycomb structure 202, the energy within period B is slightly lower than the energy associated with the Whipple shield 102 since portions of the debris field 112 may impact the cell walls 208 within the honeycomb core 204.

Period C represents the approximate time during which the debris field 112 impacts and penetrates the rear facesheet 108. For both the Whipple shield 102 and the honeycomb structure 202, the kinetic energy of the debris field 112 decreases due to the impact with the rear facesheet 108. However, the Whipple shield 102 is more effective than the honeycomb structure 202 in dissipating energy due to the channeling effect of the honeycomb core 204, as described above with respect to FIG. 2. As discussed above, the rear contact area C of the debris field 112 on the rear facesheet 108 associated with the honeycomb structure 202 is smaller than the rear contact area B in the Whipple shield 102. The smaller contact area does not allow for the degree of energy dissipation of the debris field 112 as is achieved with the Whipple shield 102.

In contrast, each impact location of the structural armor 302 provides for greater energy dissipation in periods B and C as compared to the Whipple shield 102 and honeycomb structure 202, particularly with respect to impacts at a node 312, beam 502, or valley 504. Impact at a node 312 provides the greatest degree of energy dissipation according to this example, although impacts at a beam 502 or valley 504 provide similar energy dissipation performance. It should be appreciated that the characteristics of the energy dissipation for impacts at a node 312, beam 502, and valley 504 within period C is similar to that of the Whipple shield 102. As discussed above, the angular member core 304 of the structural armor 302 includes acute node angles 316 similar to the spread angle 116 of the debris field 112 of a Whipple shield 102. In doing so, the angular member core 304 allows the debris field 112 to conically expand to the rear contact area D, which is similarly sized to the rear contact area B of the Whipple shield 102.

The energy plot associated with an impact at an aperture 506 is similar to that of the honeycomb structure 202, although with improved energy dissipation characteristics. Because of the aperture 506, the impact is similar to that of the Whipple shield 102 since there are no angular members 310 directly in the path of the debris field 112. However, the spread angle 116 of the debris field 112 may be somewhat limited due to the angular members 310 adjacent to the aperture 506, which may create limit the size of the rear contact area in a similar way as described above with respect to a honeycomb core 204. Because of the limited probability of an impact directly in the center of an aperture 506 of the angular member core 304, there is a greater likelihood of an energy plot associated with the node 312, beam 502, valley 504, or combination thereof.

Turning now to FIG. 7, an illustrative routine 700 for configuring a structural armor 302 will now be described in detail. It should be appreciated that more or fewer operations may be performed than shown in FIG. 7 and described herein. Moreover, these operations may also be performed in a different order than those described herein. The routine 700 begins at operation 702, where an angular member core 304 is configured. In doing so, a number of angular members 310 are coupled together at front nodes 312A and rear nodes 312B, according to acute node angles 316. As discussed above, the precise configuration of the structural armor 302 and corresponding angular member core 304 may be determined utilizing FEA or other techniques according to the space structure 110 application in which the structural armor 302 will be utilized. The spread angle 116 of a debris field 112 associated with a hypervelocity impact may be estimated utilizing the selected front armor facesheet 306, rear armor facesheet 308, and gap width or spacing between the two facesheets. The acute node angle 316 of each angular member 310 may be selected to be approximately equal to or less than the spread angle 116 estimation. The number and characteristics of the angular members 310 may then be determined according to the load-bearing parameters of the particular implementation, as well as according to the energy dissipation considerations associated with providing nodes 312, beams 502, and valleys 504 in the path of a debris field 112.

From operation 702, the routine 700 continues to operation 704, where a front armor facesheet 306 is coupled to the front nodes 312A. It should also be appreciate that the “coupling” may include creating the front armor facesheet 306, rear armor facesheet 308, and the angular member core 304 out of a single piece of material. Accordingly, the coupling may include any known method of bonding or creating the structural armor 302 configuration, including but not limited to brazing, casting, adhesives, laser cutting, 3D printing, mechanical folding/manipulation, or any combination of these or other known processes. At operation 706, the rear armor facesheet 308 is coupled to the rear nodes 312B in a manner similar to that used for coupling the front armor facesheet 306 to the angular member core 304.

The routine 700 continues to operation 708, where the structural armor 302 is configured as part of a space structure 110, and the routine 700 ends. As discussed above, the structural armor 302 provides load-bearing capabilities in order to provide a structural benefit to the space structure 110. In this manner, the structural armor 302 may be used as a wall or other load-bearing component rather than externally attached to the space structure 110, which would increase the weight and thickness of the space structure 110.

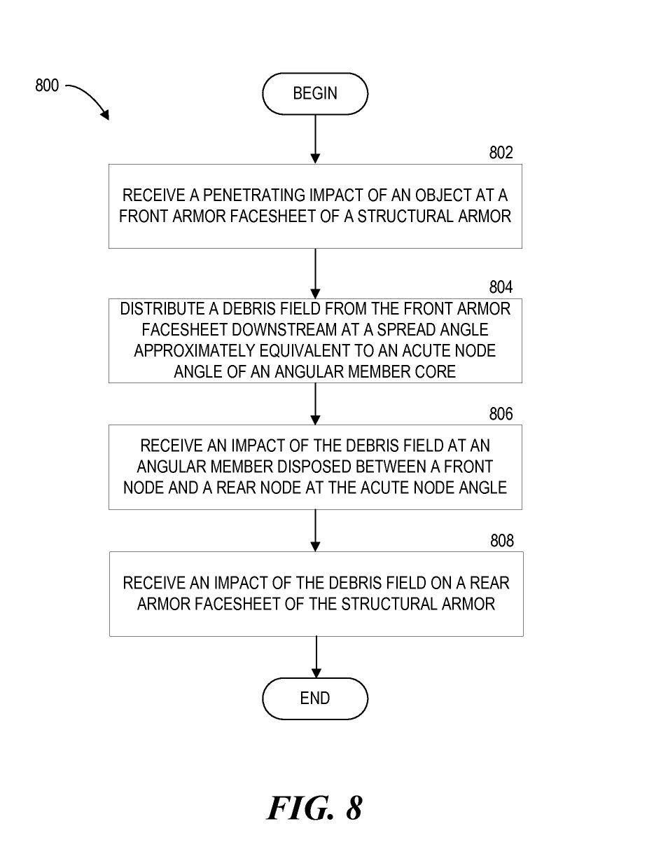

FIG. 8 shows an illustrative routine 800 for utilizing a structural armor 302 to dissipate energy from an impact with an object 104. The routine 800 begins at operation 802, where a penetrating impact of the object 104 is received at a front armor facesheet 306 of the structural armor 302. At operation 804, the resulting debris field 112 is distributed conically outward at a spread angle 116 that is approximately equivalent to the acute node angle 316 of the angular member core 304. According to some embodiments, the acute node angle 316 may be between 55 to 65 degrees.

Because of the angled configuration of the angular members 310 between the facesheets, the debris field 112 impacts one or more angular members 310 at operation 806. This impact is effective in further dissipating the kinetic energy from the debris field 112 as it travels toward the rear armor facesheet 308. At operation 808, the debris field 112 impacts the rear armor facesheet 308. Because of the acute node angle 316 of the angular member core 304, the resulting spread angle 116 of the debris field 112 provides for a rear contact area D that is larger than a corresponding rear contact area C of a honeycomb structure 202, allowing for increased energy dissipation. After the debris field 112 impacts the rear armor facesheet 308, the routine 800 ends.

It should be clear from the disclosure above that the technologies described herein provide for a structural armor 302 that may be efficiently and effectively used to provide both a load-bearing capability for a space structure 110, as well as enhanced protection against hypervelocity impacts from objects 104 in space. The configuration of the angled member core 304 having nodes 312 and angled members 310 criss-crossing between the facesheets according to acute node angles 316 simultaneously allows for optimum conical expansion of the debris field 112, while providing additional barriers in the path of the debris field 112 to further dissipate the kinetic energy prior to contact with the rear armor facesheet 308.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A structural armor for a space structure, the armor comprising:
a front armor facesheet;
a rear armor facesheet offset from the front armor facesheet; and
an angular member core having a plurality of nodes, each node abutting the front armor facesheet or the rear armor facesheet and providing a junction for a plurality of angular members intersecting at an acute node angle from the front armor facesheet or rear armor facesheet, the acute node angle selected according to a spread angle of a debris field resulting from a hypervelocity impact of an object with the front armor facesheet,
wherein the front armor facesheet, the rear armor facesheet, and the angular member core are configured to provide load-bearing capability for the space structure.

2. The structural armor of claim 1, wherein the plurality of nodes comprises a plurality of front nodes, each front node abutting the front armor facesheet, and a plurality of rear nodes, each rear node abutting the rear armor facesheet.

3. The structural armor of claim 2, wherein each angular member connects a front node to a rear node.

4. The structural armor of claim 3, wherein the spread angle comprises an angle between approximately 55 to 65 degrees.

5. The structural armor of claim 4, wherein the acute node angle comprises 60 degrees.

6. The structural armor of claim 3, wherein the plurality of angular members comprises four angular members.

7. The structural armor of claim 3, wherein the plurality of angular members comprise hollow Inconel with a circular cross-sectional shape.

8. The structural armor of claim 1, wherein the structure comprises a space structure, and wherein the front armor facesheet, the rear armor facesheet, and the angular member core are configured as a load-bearing component of the space structure.

9. A method of protecting a space structure from an impact with an object moving at hypervelocity speed, the method comprising:
receiving a penetrating impact from the object moving at hypervelocity speed on a front armor facesheet of a structural armor; and
conically distributing debris from the penetrating impact outward at a spread angle to a rear armor facesheet of the structural armor through an angular member core disposed between the front armor facesheet and the rear armor facesheet.

10. The method of claim 9, wherein the angular member core comprises a plurality of nodes, each node abutting the front armor facesheet or the rear armor facesheet and providing a junction for a plurality of angular members intersecting at an acute node angle from the front armor facesheet or rear armor facesheet.

11. The method of claim 10, wherein receiving the penetrating impact from the object on the front armor facesheet of the structural armor comprises receiving the penetrating impact from the object on the front armor facesheet at a position aligned with a front node such that the debris impacts the front node after exiting the front armor facesheet.

12. The method of claim 10, wherein receiving the penetrating impact from the object on the front armor facesheet of the structural armor comprises receiving the penetrating impact from the object on the front armor facesheet at a position aligned with a beam of an angular member such that the debris impacts the beam after exiting the front armor facesheet.

13. The method of claim 10, wherein receiving the penetrating impact from the object on the front armor facesheet of the structural armor comprises receiving the penetrating impact from the object on the front armor facesheet at a position aligned with a valley associated with a rear node such that the debris impacts the valley associated with the rear node after exiting the front armor facesheet.

14. The method of claim 10, wherein receiving the penetrating impact from the object on the front armor facesheet of the structural armor comprises receiving the penetrating impact from the object on the front armor facesheet at a position aligned with an aperture of the angular member core such that the debris traverses the aperture of the angular member core after exiting the front armor facesheet.

15. The method of claim 10, wherein the spread angle is approximately equivalent to or greater than the acute node angle.

16. A method of providing a structural armor for protecting a space structure from an impact with an object moving at hypervelocity speed, the method comprising:
configuring an angular member core having a plurality of nodes and a plurality of angular members intersecting at the plurality of nodes according to an acute node angle from a front armor facesheet or a rear armor facesheet, the acute node angle corresponding to a spread angle of a debris field resulting from a hypervelocity impact of an object with the front armor facesheet;
coupling the front armor facesheet to the angular member core; and
coupling the rear armor facesheet to the angular member core such that the plurality of angular members extend from the front armor facesheet to the rear armor facesheet.

17. The method of claim 16, wherein the plurality of nodes comprises a plurality of front nodes abutting the front armor facesheet and a plurality of rear nodes abutting the rear armor facesheet such that each angular members extends from a front node at an acute node angle from the front armor facesheet to a rear node.

18. The method of claim 17, wherein the plurality of front nodes and the plurality of rear nodes each comprise an intersection of four angular members.

19. The method of claim 18, wherein the acute node angle comprises an angle between approximately 55 to 65 degrees.

20. The method of claim 16, further comprising:
coupling the structural armor comprising the front armor facesheet, the angular member core, and the rear armor facesheet to a plurality of components of the space structure, wherein the structural armor and the plurality of components are configured as load-bearing components of the space structure.
